(19) United States
(12) Patent Application Publication
(10) Pub. No.: US 2014/0310073 A1
(43) Pub. Date: Oct. 16, 2014

(54) WIRELESS PARKING REGISTER/PAYMENT AND VIOLATION NOTIFICATION METHOD AND SYSTEM

(71) Applicant: XEROX CORPORATION, Norwalk, CT (US)

(72) Inventors: Orhan Bulan, Rochester, NY (US); Panya Chanawangsa, Williamsville, NY (US); Yao Rong Wang, Webster, NY (US); Zhigang Fan, Webster, NY (US)

(73) Assignee: Xerox Corporation, Norwalk, CT (US)

(21) Appl. No.: 13/861,553

(22) Filed: Apr. 12, 2013

(51) Int. Cl. G06Q 30/02; G07B 15/00

(52) U.S. Cl. CPC G06Q 30/0284; G07B 15/00
USPC 705/13

(57) ABSTRACT

Methods and systems for automatically managing parking payment and enforcement. In general, real-time data regarding vehicles located in a parking zone can be acquired. The number of vehicles in the parking zone can be determined from the acquired real-time data. From such data, the number of vehicles in the parking zone that are paid can be calculated. Then, an operation can be implemented to compare the number of the vehicles in the parking zone with the number of vehicles in the parking zone that are paid with respect to the current time to determine unpaid violations if the number of vehicles in the parking zone exceeds the number of vehicles that are paid.

### FIELD OF THE INVENTION

Embodiments are generally related to parking management systems. Embodiments are additionally related to wireless parking enforcement systems. Embodiments also relate to video-based parking occupancy detection technology.

### BACKGROUND

The management of an entity's available parking is a challenge to those tasked with administration of that entity. Parking is a resource that has both a diverse user group and a high level of economic and environmental impact. The available supply of parking is often much smaller than the demand for it, but is also continually changing. This results in shortages that need to be fairly distributed. Price fluctuations to meet changes in demand are also impossible to institute because of lack of timely knowledge as to the changes.

Price is not the only means by which people have tried to manage parking. They have also sought to ration parking through the use of time limits for use of the parking spaces. However, the dispersed nature of parking spaces makes monitoring of the spaces by traditional methods ineffective.

Tools exist currently to aide in the management of parking resources. The deployment of parking meters greatly enhances the ability to collect monies and monitor the use of parking spaces. However, these meters also create further management issues, as these pieces of equipment require regular preventative maintenance as well as occasional repair. Skilled personnel must perform such actions. This places an additional burden on the administrative body to monitor not only the spaces, but also the dispersed equipment, parts, and personnel, and to determine when a particular meter is out of order.

All of this monitoring and management is the challenge of parking administrators. It generally requires all or almost all of the managers time simply to keep the operation running leaving little time to devote to actual balancing of use and availability of parking spaces to the general public. In this regard, the current approaches to parking management fail to perform the function they were designed to achieve.

On-street parking violation enforcement has been an important problem for municipalities and parking management companies. Similar to many other parking violations, unpaid parking or parking in excess of paid time has been manually enforced by city officers by randomly visiting parking site and checking the parking meter (or Pay-and-Display ticket in the case of a multi-space parking meter) for each car to see if time is expired. This process is costly and inefficient in terms of labor and missed fines.

On-street parking violation enforcement is an important problem and is also a great source of revenue for municipalities, cities, local governments, etc. In 2009, for example, 10,662,000 tickets were given out for parking violations in NYC that generated $600 million revenue for the city.

One of the most difficult challenges in parking enforcement involves accurately determining the number vehicles remaining in their respective parking spots in excess of their paid time. Parking officers typically perform this enforcement by randomly visiting parking zone and ticketing vehicles in violation. This process is costly and inefficient in terms of missed fines. What is needed is an automated system that notifies parking officer when there is a vehicle with an expired parking meter or unpaid in the parking zone. Such an automated system can increase the revenue and reduce the cost for the enforcement.

Real-time parking occupancy detection systems are an emerging technology in parking management. One system for parking occupancy detection involves the use of “puck-style”/ultrasonic sensors that output a binary signal when detecting a vehicle in a parking stall. FIGS. 1-2 illustrate such sensors for parking occupancy detection in on-street parking and parking lot situations, respectively. In FIG. 1, “puck-style” sensors 15, 17, 19 and 3, 5, 7 are shown with respect to a vehicle 21 parked in a parking lot or parking zone. In FIG. 2, ultrasonic parking sensors 23, 25, and 27 are shown with respect to vehicles 29, 31, and 33 parked in a garage parking lot.

“Puck-style” in-ground sensors have been implemented in several cities providing real-time data for drivers reporting street occupancy in a city. As an alternative to sensor based solutions, video-based solutions have also been recently proposed to determine parking occupancy. In these systems, video cameras are deployed on site to monitor parking spots and the captured video is processed real-time to report available parking space to drivers.

Besides parking occupancy detection systems, another emerging technology in parking management is parking payment using a mobile phone. In one prior art implementation of this system, a zone number is assigned to each block that is indicated by signs in the parking block. A driver can make the parking payment at the time of parking using the mobile phone application by entering information including credit card number, parking zone number, license plate number, and duration of parking. In another embodiment, driver enters the departure time at the time of leaving and hence the vehicle is charged according to the time it stays in the parking area. In any case, the vehicle information is sent to a central processor to which enforcement officers have access to in order to identify vehicles that are allowed to park in a parking zone for a specific time of the day. FIG. 3 illustrates a pictorial view 34 of a sign 37 indicating the zone number for a particular block in an area for mobile phone parking payment in Washington, D.C. Such systems have already started to take place of traditional coin based parking meters and are likely to be deployed in large-scale implementations in many other cities in the future.

### SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for improved parking management methods and systems.

It is another aspect of the disclosed embodiments to provide for wireless parking enforcement methods and systems.

It is yet another aspect of the disclosed embodiments to provide for the automatic management of parking payment and enforcement.

The aforementioned aspects and other objectives and advantages can now be achieved as described herein. Methods and systems are disclosed for automatically managing parking payment and enforcement. In general, real-time data regarding vehicles located in a parking zone can be acquired through the use of, for example, traditional puck-style or in-ground sensors or video cameras. The number of vehicles in the parking zone can be determined from the acquired real-time data. A number of vehicles in the parking zone that are paid and a number of vehicles in the parking zone with open accounts are also determined. A computer server can calculate the number of vehicles paid using data received from the parking meters. The computer server can calculate the number of vehicles with open accounts by counting all open payment accounts. An account can be activated/opened by a user by sending an activation message from a mobile or on-board device at the time when he/she parks his/her vehicle. Such an activation message can contain the user's account information among other data. The account can be deactivated when the vehicle leaves. Then, an operation can be implemented to compare the number of vehicles in the parking zone with the number of vehicles in the parking zone that are paid or that have an open account with respect to the current time to determine unpaid violations if the number of vehicles in the parking zone exceeds the sum of the number of vehicles that are paid and the number of vehicles with open accounts.

Enforcement entities can be notified for unpaid violation when the number of vehicles in the parking zone is larger than the number of vehicles made the payment and the vehicles with an open account. Enforcement entities can also be notified when the parking duration of a vehicle exceeds the parking limit from parking meter in the case of pre-paid vehicles. For parking sessions not pre-paid but with an open payment account, when detecting the vehicle moving out from the parking region, operations can be performed to obtain the parking duration data for the vehicle, calculate the parking fee, and bill the user according to the register/log-in information.

### BRIEF DESCRIPTION OF THE FIGURES

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a pictorial diagram of a prior art parking occupancy detection system based on the use of “puck-style” parking sensors;

FIG. 2 illustrates a pictorial diagram of prior ultrasonic parking sensors;

FIG. 3 illustrates an example sign indicating parking zone number for mobile phone parking payment in Washington, D.C.;

FIG. 4 depicts an illustration of parking occupancy detection system based on the use of video cameras, which can be adapted for use in accordance with aspects of the disclosed embodiments;

FIG. 5 illustrates a high-level flow chart depicting logical operational steps of a method for wireless parking registration, payment, and violation notification, in accordance with a preferred embodiment;

FIGS. 6(a) and 6(b) show both stall parking scenarios and multi-space parking scenarios, which can be monitored according to one or more of the disclosed embodiments;

FIG. 7 illustrates a sample video frame depicting the FOV (Field of View) of a video camera located in an urban environment, in accordance with the disclosed embodiments;

FIG. 8 illustrates a pictorial view of an example of a mobile phone application, which can be implemented in accordance with one or more aspects of the disclosed embodiments;

FIG. 9 illustrates a portion of a web-based system that takes the occupancy data from the disclosed video detection method/system and then compares it with the registration/login data, accordance with one or more aspects of the disclosed embodiments; and

FIG. 10 illustrates a schematic representation of a processing system that can be adapted for use in accordance with one or more embodiments.

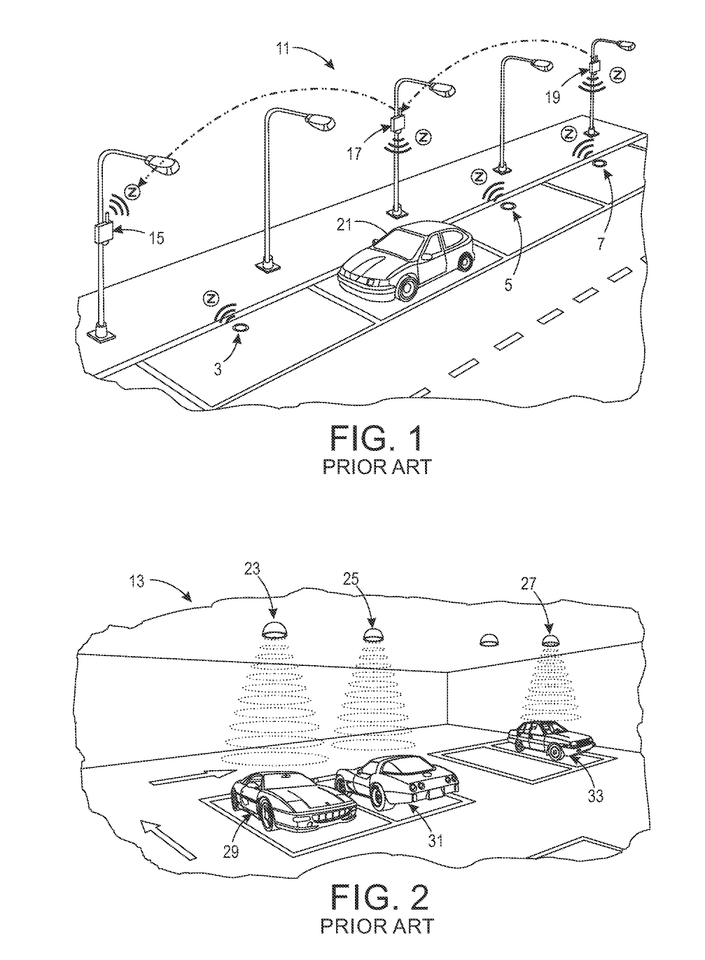

### DETAILED DESCRIPTION

The particular values and configurations discussed in these non-limiting examples can be varied and are cited merely to illustrate at least one embodiment and are not intended to limit the scope thereof.

The embodiments will now be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The disclosed embodiments describe an automatic and exact parking bill payment method and system that a driver can access, as well as an expired/unpaid parking notification method/system that enforcement agencies can utilize by fusing data derived from a parking occupancy detection system and parking payment/registration/login systems. Such a parking occupancy detection system not only detects parking occupancy, but also monitors the duration of parking. An example for such an occupancy detection system is the video-based parking management system.

As indicated earlier, parking occupancy detection systems provide real-time data about the occupancy of streets in a city and already been implemented in several cities (e.g., San Francisco). Similarly, mobile phone or web-based parking payment systems can provide an easy and convenient way for the driver to transmit a vehicle's identity (e.g., license plate number) to a central server as well as to make parking payment for parked vehicle.

Prior approaches require the knowledge of the parking vehicle's payment amount, thereby requiring the driver to pre-pay for parking time. Pre-paying for parking time may not be convenient to drivers, as parking time may not be accurately estimated in advance. The disclosed embodiments do not require pre-paying for parking time. The disclosed method/system fuses street occupancy data with parking payment/registration/login information derived from parking meters or the driver's smartphone application when parking his/her vehicle and registered/logged in. When an unpaid/unregistered vehicle or expired parking session is detected in a parking zone, the system automatically notifies enforcement entities.

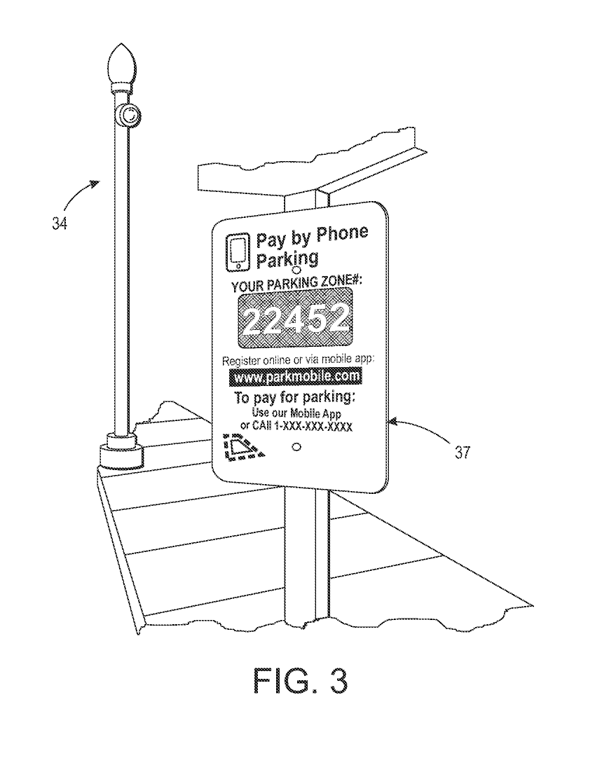

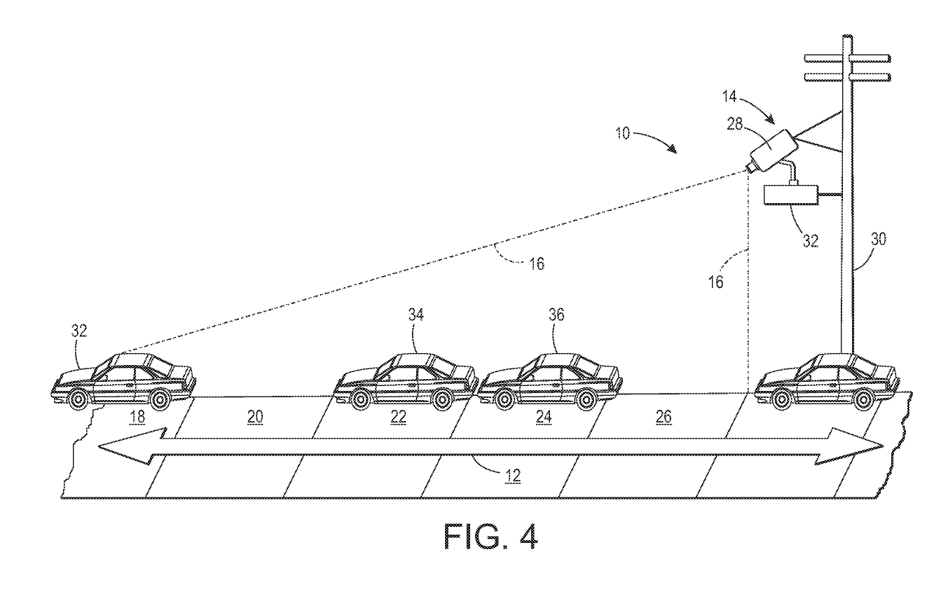

FIG. 4 depicts an illustration of a prior art parking occupancy detection system 10 based on the use of video cameras such as, for example, video camera 28. The video camera 28 in the configuration shown in FIG. 3 can monitor vehicles 32, 34, 36 within an FOV (Field of View) 16 of the video camera 28. The video camera 28 is configured to monitor the length 12 of a parking zone or parking lot and vehicles situated/parked within various parking slots 18, 20, 22, 24, 26. The video camera 28 can communicate with, for example, an antenna 30 and supported by a platform 32.

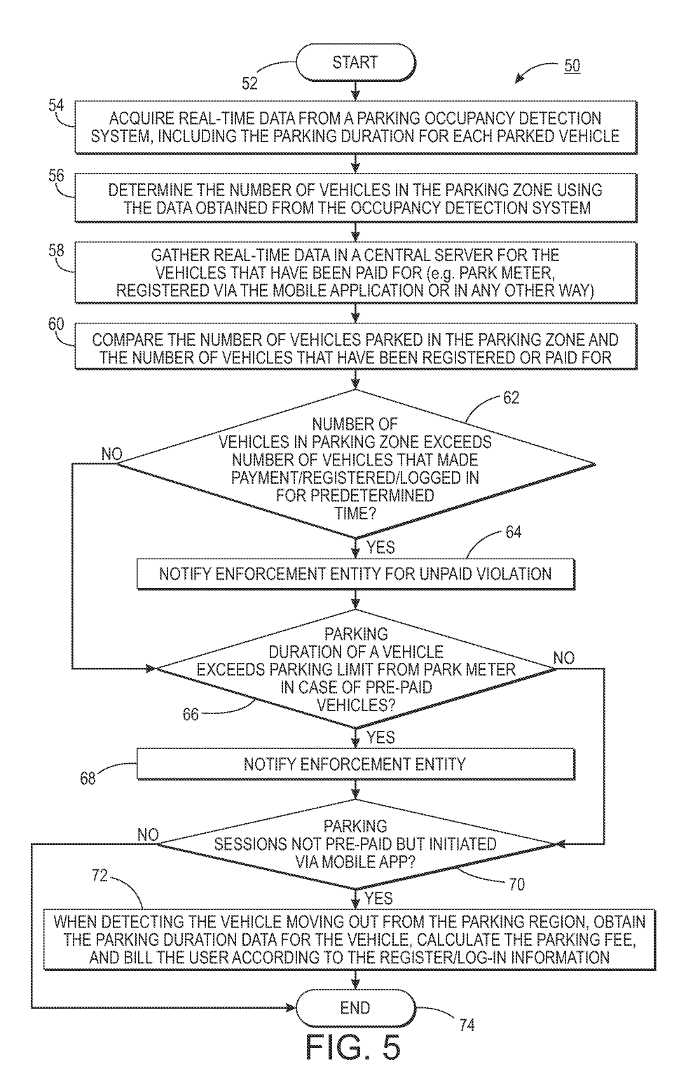

FIG. 5 illustrates a high-level flow chart depicting logical operational steps of a method 50 for wireless parking registration, payment, and violation notification in accordance with a preferred embodiment. As indicated at block 52, the process can begin. Then, as indicated at block 54, a step or logical operation can be implemented to acquire real-time data from a parking occupancy detection system (e.g., from a video-based occupancy detection system 10 shown in FIG. 4), including the parking duration for each parked vehicle. Thereafter, as depicted at block 56, a step or logical operation can be implemented to determine the number of vehicles in the parking zone using the data obtained from the occupancy detection system.

Next, as illustrated at block 58, a step or logical operation can be implemented to gather real-time data in a central server for the vehicles that have been paid for at the parking meter or for vehicles with an open account. Then, as described at block 60, a step or logical operation can be implemented to compare the number of vehicles parked in the parking zone and the number of vehicles that have been paid for or with an open account

In one embodiment, the server determines whether a parked vehicle has an activated/open account and checks whether it has received an account activation message from the detected parking vehicle. For a first time user, a registration procedure is required to set up an account. He/she may later simply login the account and activate it.

The server can be configured to receive another message from the mobile or on-board device of the parking vehicle to end the parking session, in which case the parking duration of the vehicle is calculated from the time of the beginning parking message to the time of the ending parking message. The server can also be configured to receive no message from the mobile or the on-board device of the parking vehicle for ending the parking session, in which case the parking duration for the vehicle is calculated from the time of the beginning parking message to the time of detecting the parking vehicle moving out of the parking space. In one example, the detection of the vehicle moving out of the parking space can be enabled by video analytics of a camera.

Thereafter, a test can be performed, as shown at decision block 62, to determine if the number of vehicles in the parking zone is larger than the number of vehicles (i.e., vehicle users) that made the payment/registered/logged-in for some predetermined time. Note that in some embodiments, the operations shown in blocks 62 and 60 can be combined into a single operation (e.g., a decision block). For clarification purposes, however, blocks 62 and 60 are depicted in FIG. 5 as two separate operations. In practical implementation, however, the steps or logical operations shown in blocks 62 and 60 are depicted separately. If the answer output as a result of the operation shown at block 62 is “YES”, then the proper enforcement entity can be notified regarding the unpaid violation(s), as illustrated next at block 64. If the answer is “NO”, the operation shown at decision block 66 is implemented. That is, as illustrated at decision block 66, a test can be performed to determine if the parking duration of a vehicle exceeds the parking limit from the parking meter in the case of pre-paid vehicles.

If such a determination is made (i.e., positive results), then the operation indicated at block 68 is processed. That is, the proper enforcement entity is notified when the parking duration of a vehicle exceeds the parking limit from parking meter in the case of pre-paid vehicles. If the answer is “NO”, then the operation depicted at decision block 70 is processed. That is, as shown at blocks 70 and 72, for parking sessions that are not pre-paid but initiated via a mobile application (which is described in greater detail herein), when detecting the vehicle moving out from the parking region, operations can be performed to obtain the parking duration data for the vehicle, calculate the parking fee, and bill the user according to the register/log-in information. The process can then terminate as shown at block 74.

Note that some parking occupancy detection systems are based on the use of in-ground sensors output the number of parking stalls occupied in a block, which is typically same as the number of parked vehicles. This is because street parking in some cites is still based on the situation where a parking stall has clear boundaries (e.g., typically marked by lines painted on the road surface) specified for the parking space for each vehicle. In this case, the result of the operation depicted at block 56 will be exactly the output of the occupancy detection system. Some cities, however, are eliminating single-space parking and moving into multi-space parking for maintenance cost and other reasons. Other cities will likely follow suit.

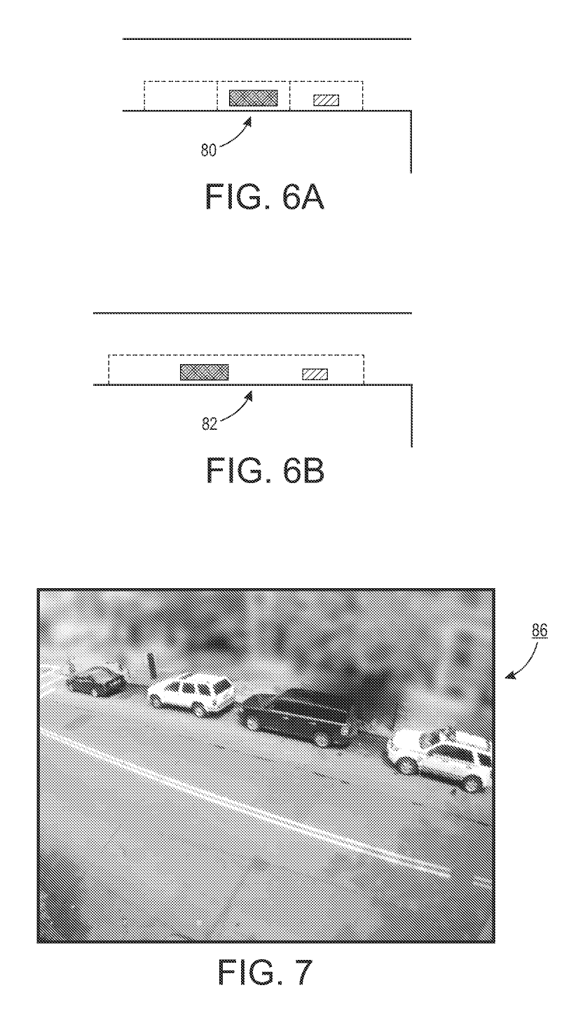

FIGS. 6(a) and 6(b) illustrate both stall parking scenarios and multi-space parking scenarios. FIG. 6(a) illustrates a stall-parking scenario 80 and FIG. 6(b) illustrates a multi-space parking scenario 82. In the multi-space parking scenario 82, the output of the occupancy detection system will be the available/occupied space in each block as well as the number of parked vehicles in the block in the case of video-based vehicle detecting system. In FIG. 6(a), the parking space for lines separate each vehicle painted on the road surface (stall parking). In FIG. 6(b), there are no pre-defined boundaries for each parking space (multi-space parking).

In a multi-space parking scenario, the output of the occupancy detection system would be the available/occupied space in each block. In this case the number of parked vehicles (N₁) can be estimated using the following equation:

N₁=round(d_{occ}/Iₐᵥ)

wherein d_{occ} is the occupied space in a block and Iₐᵥ is the average length of typical vehicles. And the number of unpaid vehicles (N₂) can then be determined by subtracting number of paid vehicles and vehicles with an open account from the estimated number of parked vehicles (N₁).

A better approach to estimate number of vehicles in violation would be by using the parked vehicle information (e.g., vehicle length) gathered by the parking payment system. In the process of parking payment (e.g., using mobile phone application), parked vehicle information (e.g., vehicle make and model) can be also requested. This information can then be used to calculate the occupied space (d_{cal}) in a block, which can be compared with the output of the occupancy detection system to determine the number of vehicles in violation (N₂). In this case, N₂ can be estimated as:

N₂=round((d_{occ}−d_{cal})/Iₐᵥ)

FIG. 7 illustrates a sample video frame 86 illustrating the FOV (Field of View) from a video camera in an urban environment, in accordance with the disclosed embodiments. The disclosed notification methods and systems include two fundamental components: a) an occupancy detection system, and b) a parking register/payment system.

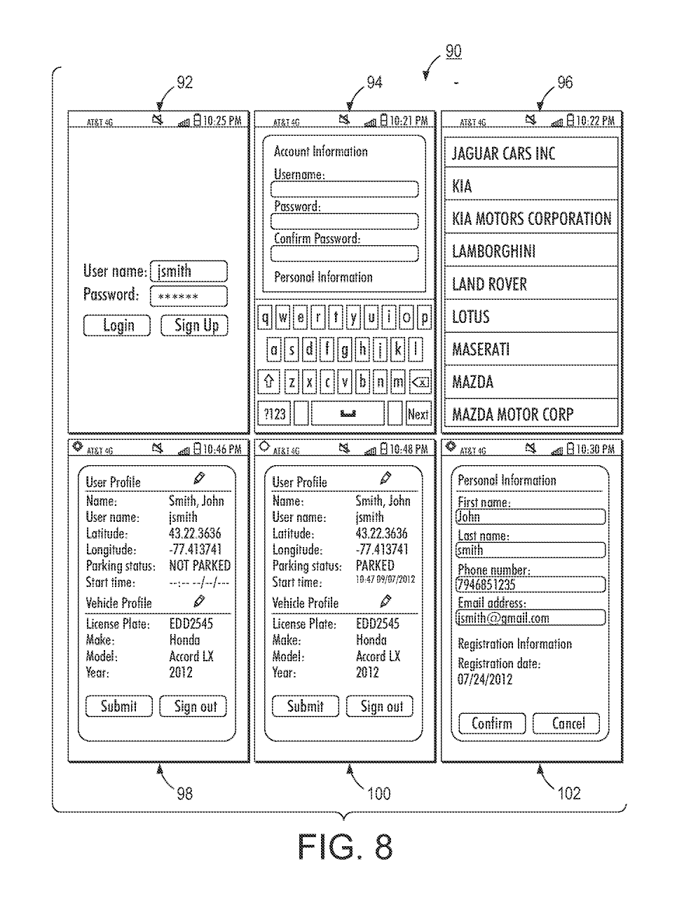

A mobile phone parking register/payment application can be implemented in the context of, for example, an Android/iPhone platform to enable users to register and enter parking information. FIG. 8 illustrates a pictorial view 90 of an example of such a mobile phone application, in accordance with one or more aspects of the disclosed embodiments. Examples of such an application include a login screen 92, a screen 94 for entering account information, and a screen 96 wherein a particular type of vehicle is selected and used in developing the user profile. Screens 98 and 100 allow a user to enter his or her user profile information, and screen 102 allows for input of personal information such as name, e-mail address, etc.

This application allows the user to register his/her vehicle for the first time with the vehicle information, which contains the vehicle's identification such as the license plate number, information on how to bill the user for parking fee, and other additional information. When the user parks his/her car, he/she is required to initiate a parking session by logging in to the application and pressing the submit button. In doing so, his/her account information as well as the GPS coordinates are transmitted to the central server. Otherwise, our video occupancy detection system will treat the vehicle as a violation unless the user has pre-paid at the parking meter. The video occupancy detection method/system of the disclosed embodiments will monitor the vehicle as well as the duration of parking.

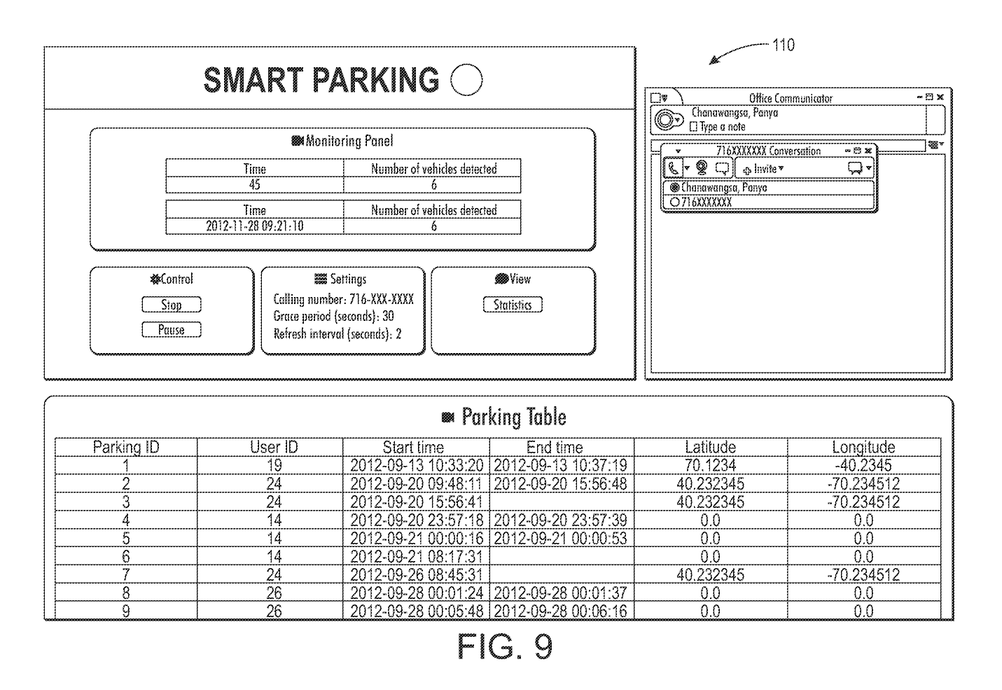

FIG. 9 illustrates a portion of a web-based system 110 that takes the occupancy data from the disclosed video detection method/system and then compares it with the registration/login data, accordance with one or more aspects of the disclosed embodiments. A parking violation is detected when the number of vehicles obtained from the video occupancy detection system is greater than the number of registered vehicles. After a predefined grace period, the system automatically notifies a parking enforcer via a phone call. The system administrator also has the ability to view the information of all the registered vehicles and active parking sessions.

The disclosed methods/systems can be implemented in the context of hardware circuits, and/or some parts can be implemented in software in any computer language, run by conventional processing hardware such as a general-purpose microprocessor, or application specific integrated circuits for example.

For example, such methods and/or systems may be implemented as a controller and can be implemented as hardware, computer software, or combinations of both. Such a controller may include a general purpose processor, an embedded processor, an application specific integrated circuit (ASIC), a field programmable gate array (FPGA) or other programmable logic device, discrete gate or transistor logic, discrete hardware components, or any combination designed to perform the functions described herein. A processor may also be implemented as a combination of computing devices, e.g., a combination of an FPGA and a microprocessor, a plurality of microprocessors, one or more microprocessors in conjunction with an FPGA, or any other such configuration.

Embodiments can also be realized via a processor system. Such a processing system may include a computing device or processing engine, e.g., a microprocessor, a server, etc. Any of the methods described above according to embodiments of the present invention or claimed may be implemented in, for example, a processing system 40.

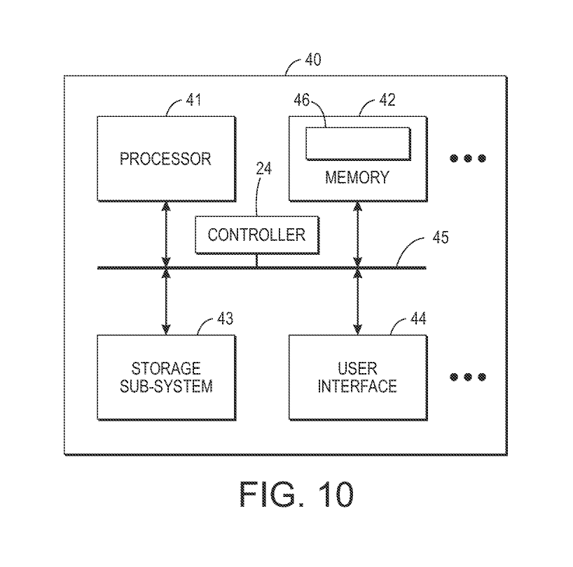

FIG. 10 illustrates one possible configuration of processing system 40 that can include, for example, at least one customizable or programmable processor 41 coupled to a memory subsystem 42 that includes at least one form of memory, e.g., RAM, ROM, and so forth. It is to be noted that the processor 41 or processors may be a general purpose, or a special purpose processor, and may be for inclusion in a device, e.g., a chip that has other components that perform other functions.

Thus, one or more aspects of the method according to embodiments of the present invention can be implemented in digital electronic circuitry, or in computer hardware, firmware, software, or in combinations of them. The processing system may include a storage subsystem 43 that has at least one disk drive and/or CD-ROM drive and/or DVD drive. In some cases, storage subsystem 43 may include, for example, a USB drive or a port for access a USB storage drive or Flash drive. In some implementations, a display system, a keyboard, and a pointing device may be included as part of a user interface 44 to provide for a user to manually input information such as parameter values. An example of such a user interface is a GUI (Graphical User Interface). Ports for inputting and outputting data may be included.

More elements such as network connections, interfaces to various devices, and so forth, may be included, but are not illustrated in FIG. 10. The various elements of the processing system 40 may be coupled in various ways, including via a bus subsystem 45 shown in FIG. 4 for simplicity as a single bus, but which will be understood to those in the art to include a system of at least one bus. The memory of the memory subsystem 42 may at some time hold part or all of a set of instructions that when executed on the processing system 40 implements the steps of the method embodiments described herein. A module 46 (e.g., a software module) stored within memory 42 may contain such instructions. For example, module 46 may contain instructions for carrying out the various steps or logical operations shown in the various blocks of FIG. 5.

Embodiments can also include a computer program product, which provides the functionality of any of the methods according to the present invention when executed on a computing device such as a processing engine. Software according to the present invention, when executed on a processing engine, can contain code segments that provide, for example, software and instructions thereof for carrying out the steps or logical operations shown in FIG. 5 and operations with respect to the various components shown in other figures herein.

Such a computer program product can be tangibly embodied in a carrier medium carrying machine-readable code for execution by a programmable processor. The present invention thus relates to a carrier medium carrying a computer program product that, when executed on computing means, provides instructions for executing any of the methods as described above. The term “carrier medium” refers to any medium that participates in providing instructions to a processor for execution. Such a medium may take many forms, including but not limited to, non-volatile media, and transmission media. Non-volatile media includes, for example, optical or magnetic disks such as a storage device, which is part of mass storage.

Common forms of computer readable media include a CD-ROM, a DVD, a flexible disk or floppy disk, a tape, a memory chip or cartridge or any other medium from which a computer can read. Various forms of computer readable media may be involved in carrying one or more sequences of one or more instructions to a processor for execution. The computer program product can also be transmitted via a carrier wave in a network such as a LAN, a WAN or the Internet. Transmission media can take the form of acoustic or light waves such as those generated during radio wave and infrared data communications. Transmission media include coaxial cables, copper wire, and fiber optics, including the wires that comprise a bus within a computer.

Processing system 10 thus constitutes a processor-readable medium storing code representing instructions to cause, for example, a process for automatically managing parking payment and enforcement (e.g., the method/process described herein). Such code in some embodiments can include code to determine the number of vehicles in a parking zone from real-time data acquired regarding the vehicles located in the parking zone. Such code can further include code to calculate the number of the vehicles in the parking zone that are paid to a parking meter associated with the parking zone. In addition, such code can include code to calculate the number of the vehicles that have an open account for payment. Such code can also include code to compare the number of the vehicles in the parking zone with the number of vehicles in the parking zone that are paid with respect to a current time, with the number of vehicles that have an open account for payment to determine unpaid violations if the number of vehicles in the parking zone exceeds the number of vehicles that are paid, registered to pay, and having an account to pay.

It will be appreciated that variations of the above-disclosed and other features and functions, or alternatives thereof, may be desirably combined into many other different systems or applications. Also, that various presently unforeseen or unanticipated alternatives, modifications, variations or improvements therein may be subsequently made by those skilled in the art which are also intended to be encompassed by the following claims.

What is claimed is:

1. A method for automatically managing parking payment and enforcement, said method comprising:
determining a number of vehicles in a parking zone from real-time data acquired regarding said vehicles located in said parking zone;
calculating a number of said vehicles in said parking zone that are paid to a parking meter associated with said parking zone;
calculating a number of said vehicles that have an open account for payment; and
comparing said number of said vehicles in said parking zone with said number of vehicles in said parking zone that are paid with respect to a current time, with said number of vehicles that have an open account for payment to determine unpaid violations if said number of vehicles in said parking zone exceeds said number of vehicles that are paid, registered to pay, and having an account to pay.

2. The method of claim 1 further comprising acquiring said real-time data regarding said vehicles locating in said parking zone utilizing a video-based occupancy detection system.

3. The method of claim 1 wherein said account for payment is opened when an account activation message is received.

4. The method of claim 1 wherein said account for payment is dosed when an account deactivation message is received or when said vehicle leaves said parking zone

5. The method of claim 3 wherein said account activation message is capable of being transmitted by mobile devices or vehicle onboard wireless devices.

6. The method of claim 4 wherein said account deactivation message is capable of being transmitted by mobile devices or vehicle onboard wireless devices.

7. The method of claim 1 further comprising automatically notifying an enforcement entity when a parking duration of a vehicle that is paid in said parking zone exceeds a parking payment duration of a pre-paid vehicle.

8. The method of claim 1 further comprising for a vehicle that is not pre-paid but with an open payment account, as said vehicle moves away from said parking region:
automatically obtaining a parking duration for said vehicle parked in said parking zone and calculating a parking fee amount with respect to said vehicle in said parking zone; and
automatically generating a bill according to registration data associated with said vehicle.

9. The method of claim 1 further comprising:
determining said unpaid violations by estimating a number of vehicles in said parking lot utilizing gathered parked vehicle data; and
calculating based on said gathered paid and registered vehicle data, an occupied space (d_{cal}) in a block which is comparable with the detected occupied space (d_{occ}) from occupancy detection data to determine a number of vehicles in violation (N₂), wherein N₂ is estimated as N₂=round((d_{occ}−d_{cal})/Iₐᵥ), where Iₐᵥ is vehicle's average length.

10. A system for automatically managing parking payment and enforcement, said system comprising:
a processor;
a data bus coupled to said processor; and
a computer-usable medium embodying computer program code, said computer-usable medium being coupled to said data bus, said computer program code comprising instructions executable by said processor and configured for:
determining a number of vehicles in a parking zone from real-time data acquired regarding said vehicles located in said parking zone;
calculating a number of said vehicles in said parking zone that are paid to a parking meter associated with said parking zone;
calculating a number of said vehicles that have an open account for payment; and
comparing said number of said vehicles in said parking zone with said number of vehicles in said parking zone that are paid with respect to a current time, with said number of vehicles that have an open account for payment to determine unpaid violations if said number of vehicles in said parking zone exceeds said number of vehicles that are paid, registered to pay, and having an account to pay.

11. The system of claim 10 wherein said instructions are further configured for acquiring said real-time data regarding said vehicles located in said parking zone utilizing a video-based occupancy detection system.

12. The system of claim 10 wherein said instructions are further configured for gathering said real-time data in a server with respect to said vehicles in said parking zone that are paid and made payment thereof through alternative payment platforms.

13. The system of claim 10 wherein said instructions are further configured for gathering said real-time data in a server with respect to said vehicles in said parking zone that are associated with open payment account by calculating a difference between a number of activated accounts and a number of deactivated accounts.

14. The system of claim 13 wherein said number of activated accounts is determined by counting a number of activating messages received.

15. The system of claim 13 wherein said number of deactivated accounts is determined by counting a number of vehicles that have parked in said parking zone and have later left said parking zone.

16. A processor-readable medium storing code representing instructions to cause a process for automatically managing parking payment and enforcement, said code comprising code to:
determine a number of vehicles in a parking zone from real-time data acquired regarding said vehicles located in said parking zone;
calculate a number of said vehicles in said parking zone that are paid to a parking meter associated with said parking zone;
calculate a number of said vehicles that have an open account for payment; and
compare said number of said vehicles in said parking zone with said number of vehicles in said parking zone that are paid with respect to a current time, with said number of vehicles that have an open account for payment to determine unpaid violations if said number of vehicles in said parking zone exceeds said number of vehicles that are paid, registered to pay, and having an account to pay.

17. The processor-readable medium of claim 16 wherein said code further comprises code to acquire said real-time data regarding said vehicles located in said parking zone utilizing a video-based occupancy detection system.

18. The processor-readable medium of claim 16 wherein said code further comprises code to:
open said account for payment when an account activation message is received; and
close said account for payment when an account deactivation message is received or when said vehicle leaves said parking zone.

19. The processor-readable medium of claim 16 wherein said code further comprises code to automatically notify an enforcement entity when a parking duration of a vehicle that is paid in said parking zone exceeds a parking payment duration of a pre-paid vehicle.

20. The processor-readable medium of claim 17 wherein for a vehicle that is not pre-paid but with an open payment account, as said vehicle moves away from said parking region, said code further comprises code to:
automatically obtain a parking duration for said vehicle parked in said parking zone and calculate a parking fee amount with respect to said vehicle in said parking zone; and
automatically generate a bill according to registration data associated with said vehicle.
